(19) United States
(12) Patent Application Publication
(10) Pub. No.: US 2026/0230669 A1
(43) Pub. Date: Aug. 6, 2026

(54) INFORMATION PROCESSING APPARATUS, CONTROL METHOD THEREOF, AND PROGRAM

(71) Applicant: Yokogawa Electric Corporation, Musashino-shi, Tokyo (JP)

(72) Inventors: Osamu KOJIMA, Musashino-shi, Tokyo (JP); Atsushi WADA, Musashino-shi, Tokyo (JP)

(73) Assignee: Yokogawa Electric Corporation, Musashino-shi, Tokyo (JP)

(21) Appl. No.: 19/149,754

(22) PCT Filed: Dec. 7, 2023
(86) PCT No.: PCT/JP2023/043882

§ 371 Date: Jul. 21, 2025

(30) Foreign Application Priority Data
Jan. 23, 2023 (JP) 2023-008342

(51) Int. Cl. H04N 21/431; H04N 21/2187; H04N 21/472

(52) U.S. Cl. CPC H04N 21/4318; H04N 21/2187; H04N 21/47217

(57) ABSTRACT

An information processing apparatus capable of communicating with an imaging apparatus that captures video composed of frame images, the information processing apparatus including a controller that controls the imaging apparatus to capture images in a fixed imaging range according to a preset patrol schedule, acquires an edited video generated by editing a recorded video that is a video captured by the imaging apparatus between an end of a first patrol schedule and a start of a second patrol schedule, which is a next patrol schedule after the first patrol schedule, acquires a live video that is video captured by the imaging apparatus according to the second patrol schedule, and displays the live video and the edited video on a display.

### CROSS-REFERENCE TO RELATED APPLICATION

The present application claims priority to Japanese Patent Application No. 2023-008342 filed on Jan. 23, 2023, the entire contents of which are incorporated herein by reference.

### TECHNICAL FIELD

The present disclosure relates to an information processing apparatus, a control method thereof, and a program.

### BACKGROUND

In order to use surveillance cameras to simulate patrols by security guards, a surveillance system that conducts a “camera patrol” (also called “video patrol” or “preset patrol”) is known. In this system, a plurality of cameras is used to capture images by sequentially switching the camera, or a single camera is used by sequentially switching the angle of view, orientation, and the like of the camera to preset values (the angle of view and orientation of the camera are set as values indicating pan/tilt/zoom (PTZ), for example). Patent literature (PTL) 1 discloses a surveillance system that controls the automatic patrolling by such a surveillance camera in combination with other sensors.

### CITATION LIST

### Patent Literature

PTL 1: JP 2010-103773 A

### SUMMARY

### Technical Problem

However, conventional monitoring systems only present the current images and the like captured by cameras during automatic patrolling, and the user needs to check for anomalies by examining only the current images and information being presented. Therefore, with a conventional monitoring system, events that occurred between the previous and current patrols cannot be grasped. Such a monitoring system thus has room for improvement in the ability to detect anomalies at the position where images are captured.

It would be helpful to facilitate detection of anomalies in monitoring systems.

### Solution to Problem

An information processing apparatus according to several embodiments is
(1) an information processing apparatus capable of communicating with an imaging apparatus that captures video composed of a plurality of frame images, the information processing apparatus including a controller configured to:
control the imaging apparatus to capture images in a fixed imaging range according to a patrol schedule that is set in advance;
acquire an edited video generated by editing a recorded video that is a video captured by the imaging apparatus between an end of a first patrol schedule and a start of a second patrol schedule, which is a next patrol schedule after the first patrol schedule;
acquire a live video that is video captured by the imaging apparatus according to the second patrol schedule; and
display the live video and the edited video on a display.

The information processing apparatus thus displays, side by side, not only live video but also an edited video of the recorded video between the end of the first patrol schedule and the second patrol schedule. Therefore, the user, such as a guard, can find not only anomalies that are currently occurring at the monitored location, but also anomalies that have occurred at the monitored location between the check during the previous patrol schedule and the current patrol schedule. In addition, even if there is a difference in the live video during the current patrol compared to the live video in the previous patrol, the user can grasp the cause and circumstances of the difference by use of the edited video and determine whether the difference indicates an anomaly. According to the information processing apparatus, detection of anomalies in monitoring systems can thereby be facilitated.

In an embodiment,
(2) in the information processing apparatus of (1),
the controller may be configured to acquire, as the edited video, a video generated by playing back the recorded video in fast-forward at a constant speed over a period from the end of the first patrol schedule to the start of the second patrol schedule, or a video that continuously plays back video of a portion in which motion is detected in the recorded video.

The information processing apparatus thus acquires and displays, as the edited video, a video generated by playing back the recorded video in fast-forward at a constant speed or a video that continuously plays back video of a portion in which motion is detected in the recorded video. Therefore, the user can check the current video while referring to the edited video, in particular to the video that was captured between the end of the first patrol schedule and the start of the second patrol schedule and requires attention. The user can thus detect anomalies more easily.

In an embodiment,
(3) in the information processing apparatus of (1),
the information processing apparatus may be capable of communicating with a detection apparatus that detects an occurrence of a predetermined event, and
the controller may be configured to
   acquire information including a time of occurrence and a type of each event detected by the detection apparatus between the end of the first patrol schedule and the start of the second patrol schedule, and
   further display, on the display, a list image that is an image including a list display of the time of occurrence and the type of each event detected by the detection apparatus between the end of the first patrol schedule and the start of the second patrol schedule.

The information processing apparatus thus displays, together with the live video and the edited video, a list image that is an image including a list display of the time of occurrence and the type of each detected event between the end of the first patrol schedule and the start of the second patrol schedule. Therefore, the user can check the current live video while recognizing the time of occurrence, type, and the like of events and can more easily detect anomalies that have occurred between the previous patrol schedule and the present.

In an embodiment,
(4) in the information processing apparatus of (3),
the controller may be configured to acquire, as the edited video, a video that continuously plays back a portion of the recorded video corresponding to the time of occurrence of the event detected by the detection apparatus.

The information processing apparatus thus acquires and displays, as edited images, a video that continuously plays back a portion of the recorded video corresponding to the time of occurrence of the event. Therefore, the user can refer to the edited video corresponding to the detected event to check, in greater detail, the anomaly caused by the event that occurred.

In an embodiment,
(5) in the information processing apparatus of (4),
the controller may be configured to highlight, in the list image, the event corresponding to the edited video displayed on the display.

The information processing apparatus thus highlights the event corresponding to the currently displayed edited video in the list image. The user can thereby more easily recognize the event corresponding to the currently displayed edited video.

In an embodiment,
(6) in the information processing apparatus of (5),
the controller may be configured to further display, on the display, an image indicating a correspondence between the event highlighted in the list image and the edited video.

When simultaneously displaying the live video, the edited image, and the list image, the information processing apparatus thus further displays an image indicating the correspondence between the event highlighted in the list image and the edited video. Therefore, the user can more easily recognize the correspondence between the content of the currently displayed edited video and the detected event.

In an embodiment,
(7) in the information processing apparatus of any one of (3) to (6),
the information processing apparatus may be capable of communicating with a measurement apparatus that measures a predetermined physical quantity, and
the controller may be configured to
   acquire information indicating a change over time in the physical quantity measured by the measurement apparatus between the end of the first patrol schedule and the start of the second patrol schedule, and
   further display, on the display, a graph indicating the change over time in the physical quantity measured by the measurement apparatus between the end of the first patrol schedule and the start of the second patrol schedule.

The information processing apparatus thus displays, together with the live video, the edited video, and the list image, a graph of the physical quantity measured between the end of the first patrol schedule and the start of the second patrol schedule. Therefore, when there is an anomalous change in the physical quantity, for example, the user can recognize the change by comparison with the edited video and the list image and can check the current live video. The user can thereby more easily detect anomalies.

In an embodiment,
(8) in the information processing apparatus of (7),
the controller may be configured to
   determine that the event has occurred by the physical quantity measured by the measurement apparatus satisfying a predetermined condition, and
   further display, on the display, an event image indicating occurrence of the determined event at a position on the graph corresponding to a time and the physical quantity of the determined event.

The information processing apparatus thus displays an event image indicating the occurrence of an event at a position on the graph corresponding to the time and physical quantity of the determined event. Therefore, the user can easily recognize the time, physical quantity, and the like in the graph for the event that occurred.

In an embodiment,
(9) in the information processing apparatus of (8),
the controller may be configured to further display, as the list image on the display, an image that further includes a display of the time of occurrence and the type of each event determined based on the physical quantity.

The information processing apparatus thus displays events determined based on the measured physical quantities in the list image, enabling the user to check, in the list image, not only the events detected by the detection apparatus but also the events determined based on the physical quantities.

In an embodiment,
(10) in the information processing apparatus of (9), the controller may be configured to further display, on the display, an image indicating a correspondence between the event image and the display in the list image of the event indicated by the event image.

When simultaneously displaying the live video, the edited video, the list image of events, and the graph of the physical quantity, the information processing apparatus thus further displays an image indicating the correspondence between the event image on the graph and the display of the event in the list image. Therefore, the user can more easily recognize the correspondence between the graph of the physical quantity and the events displayed in the list image.

In an embodiment,
(11) in the information processing apparatus of any one of (1) to (10), the controller may be configured to further display, on the display, an image indicating a temporal position of the edited video currently displayed on the display.

The information processing apparatus thus displays the temporal position of the currently displayed edited video, enabling the user easily to check the time of the currently displayed edited video.

A control method of an information processing apparatus according to several embodiments is
(12) a control method of an information processing apparatus capable of communicating with an imaging apparatus that captures video composed of a plurality of frame images, the control method including:
controlling, by a controller of the information processing apparatus, the imaging apparatus to capture images in a fixed imaging range according to a preset patrol schedule;
acquiring, by the controller, an edited video generated by editing a recorded video that is a video captured by the imaging apparatus between an end of a first patrol schedule and a start of a second patrol schedule, which is a next patrol schedule after the first patrol schedule;
acquiring, by the controller, a live video that is video captured by the imaging apparatus according to the second patrol schedule; and
displaying, by the controller, the live video and the edited video on a display.

The information processing apparatus thus displays, side by side, not only live video but also an edited video of the recorded video between the end of the first patrol schedule and the second patrol schedule. Therefore, the user, such as a guard, can find not only anomalies that are currently occurring at the monitored location, but also anomalies that have occurred at the monitored location between the check during the previous patrol schedule and the current patrol schedule. In addition, even if there is a difference in the live video during the current patrol compared to the live video in the previous patrol, the user can grasp the cause and circumstances of the difference by use of the edited video and determine whether the difference indicates an anomaly. According to the information processing apparatus, detection of anomalies in monitoring systems can thereby be facilitated.

A program according to several embodiments is
(13) a program configured to cause a computer to perform operations including:
controlling an imaging apparatus to capture video composed of a plurality of frame images in a fixed imaging range according to a preset patrol schedule;
acquiring an edited video generated by editing a recorded video that is a video captured by the imaging apparatus between an end of a first patrol schedule and a start of a second patrol schedule, which is a next patrol schedule after the first patrol schedule;
acquiring a live video that is video captured by the imaging apparatus according to the second patrol schedule; and
displaying the live video and the edited video on a display.

The computer that operates according to the program thus displays, side by side, not only live video but also an edited video of the recorded video between the end of the first patrol schedule and the second patrol schedule. Therefore, the user, such as a guard, can find not only anomalies that are currently occurring at the monitored location, but also anomalies that have occurred at the monitored location between the check during the previous patrol schedule and the current patrol schedule. In addition, even if there is a difference in the live video during the current patrol compared to the live video in the previous patrol, the user can grasp the cause and circumstances of the difference by use of the edited video and determine whether the difference indicates an anomaly. According to the program, detection of anomalies in monitoring systems can thereby be facilitated.

### Advantageous Effect

According to an embodiment of the present disclosure, detection of anomalies in monitoring systems can be facilitated.

### BRIEF DESCRIPTION OF THE DRAWINGS

In the accompanying drawings:

FIG. 1 is a diagram illustrating an example functional configuration of a monitoring system according to an embodiment;

FIG. 2 is a diagram illustrating an example hardware configuration of the server apparatus in FIG. 1;

FIG. 3 is a diagram illustrating an example hardware configuration of the client apparatus in FIG. 1;

FIG. 4 is a flowchart illustrating an example of operations by a monitoring system according to an embodiment;

FIG. 5 is a diagram illustrating an example screen displayed on the client apparatus;

FIG. 6 is a diagram illustrating an example screen displayed in an area in FIG. 5;

FIG. 7 is a diagram illustrating an example screen displayed in an area in FIG. 5;

FIG. 8 is a diagram illustrating an example screen displayed on the client apparatus;

FIG. 9 is a diagram illustrating an example screen displayed on the client apparatus; and

FIG. 10 is a diagram illustrating an example of a report document generated by a monitoring system.

### DETAILED DESCRIPTION

### COMPARATIVE EXAMPLE

A monitoring system according to a comparative example (claim 1 of PTL 1) is a video patrol monitoring system that switches and outputs a plurality of externally inputted video signals based on a state of a plurality of externally inputted sensor detection signals, the video patrol monitoring system including video input means having a plurality of video signal input interfaces configured to input the plurality of video signals respectively; memory means for storing a patrol sequence indicating whether each of the inputted plurality of video signals is a switching target; switching control means for selecting one video signal input interface by switching among the plurality of video signal input interfaces in accordance with the patrol sequence; video signal output means for externally outputting the video signal inputted to the selected video signal input interface; detection signal input means for inputting the plurality of sensor detection signals; sensor state management means having a management table that maps the plurality of sensor detection signals to the plurality of video signals and classifying the state of each of the plurality of sensor detection signals into a detection state or a non-detection state; and patrol sequence management means for updating the patrol sequence based on the management table so that a video signal input interface that inputs a video signal corresponding to a sensor detection signal classified as the detection state is set to the switching target and a video signal input interface that inputs a video signal corresponding to a sensor detection signal classified as the non-detection state is set to a non-switching target.

However, the monitoring system according to the comparative example only presents video and the like captured by cameras during automatic patrol, and the user needs to check for anomalies by examining the video and the like presented in the automatic patrol. Conventional monitoring systems can therefore only check for anomalies at the time of a patrol.

The monitoring system of the present disclosure displays a combination of edited video of the recorded video for the time between the previous patrol and the current patrol, events that occurred during that time, or values of physical quantities measured by sensors, thus enabling users to grasp anomalous situations that have occurred between patrols.

### EMBODIMENTS

Embodiments of the present disclosure are now described with reference to the drawings. Portions having an identical configuration or function in the drawings are labeled with the same reference signs. In the explanation of the embodiments, a redundant description of identical portions may be omitted or simplified as appropriate.

### Monitoring system

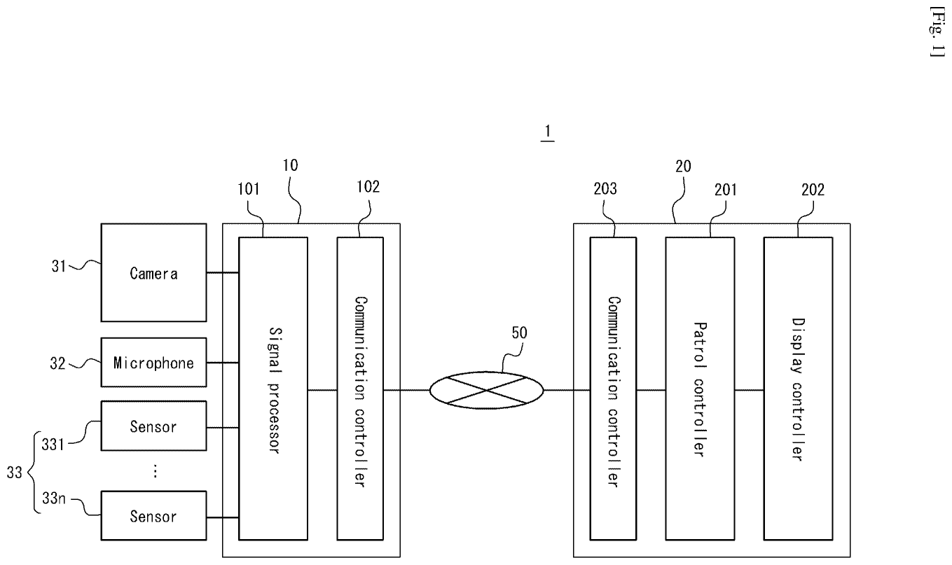

FIG. 1 is a diagram illustrating an example functional configuration of a monitoring system 1 according to an embodiment. The monitoring system 1 monitors a building, facility, outdoor area, or the like targeted for monitoring (hereinafter referred to as a “target facility”). The monitoring system 1 includes a server apparatus 10, a client apparatus 20, a camera 31, a microphone 32, and sensors 33 (331, . . . , 33n). The server apparatus 10 and the client apparatus 20 are communicably connected to a network 50 including, for example, the Internet, an intranet, and a mobile communication network.

The server apparatus 10 as an information processing apparatus according to the present embodiment is an apparatus that acquires video and signals from the camera 31, the microphone 32, and the sensors 33 (331, . . . , 33n), performs necessary signal processing, and then provides the video and signals to the client apparatus 20. The server apparatus 10 is connected to the camera 31, the microphone 32, and the sensors 33 (331, . . . , 33n). The server apparatus 10 includes the functional elements of a signal processor 101 and a communication controller 102. The signal processor 101 controls the operations of the camera 31, the microphone 32, and the sensors 33 (331, . . . , 33n) and receives video and signals from these apparatuses. The communication controller 102 performs communication control to provide the video and signals subjected to signal processing to the client apparatus 20. In the present embodiment, the server apparatus 10, together with the camera 31, the microphone 32, and the sensors 33 (331, . . . , 33n), is installed inside the target facility, but the server apparatus 10 may be installed outside the target facility and communicate with the camera 31, the microphone 32, and the sensors 33 (331, . . . , 33n) via the network 50.

The client apparatus 20 is an apparatus operated by a user, such as a guard. The client apparatus 20 receives and displays video and signals from the server apparatus 10. The client apparatus 20 can communicate with the server apparatus 10 via the network 50. The client apparatus 20 includes the functional elements of a patrol controller 201, a display controller 202, and a communication controller 203. The patrol controller 201 generates control signals for the camera 31, the microphone 32, and the sensors 33 (331, . . . , 33n) to automatically conduct a camera patrol inside the target facility according to predefined procedures. The display controller 202 controls the display to the user according to communication with the server apparatus 10. The communication controller 203 executes processing to transmit, to the server apparatus 10, control signals for the camera 31 and the like as generated by the patrol controller 201 and to receive, from the server apparatus 10, the video and signals subjected to signal processing by the server apparatus 10. In the present embodiment, an example in which the number of client apparatuses 20 included in the monitoring system 1 is one is described, but the number of client apparatuses 20 may be freely set.

The camera 31 as an imaging apparatus according to the present embodiment is installed in the target facility and captures images of the target facility to acquire video (moving images) composed of a plurality of frame images. The camera 31 is, for example, a PTZ camera, but the shape and functions may be freely chosen. In the present embodiment, an example in which the number of cameras 31 included in the monitoring system 1 is one is described, but the number of cameras 31 may be freely chosen.

The microphone 32 is installed in the target facility and acquires audio signals generated inside the target facility. In the present embodiment, an example in which the number of microphones 32 included in the monitoring system 1 is one is described, but the number of microphones 32 may be freely chosen.

The sensors 33 (331, . . . , 33n) detect the occurrence of various events that occur at the target facility and measure physical quantities related to the events. Hereinafter, the sensors 331, . . . , 33n may be referred to collectively as the “sensors 33”. The sensors 33 may, for example, be door open/close sensors, human detection sensors, intrusion detection sensors, fire sensors (fire alarms), smoke sensors (smoke detectors), temperature sensors, humidity sensors, CO₂ (carbon dioxide) concentration sensors, illuminance sensors, or traffic sensors, but these examples are not limiting. In the present embodiment, an example in which the number of sensors 33 (331, . . . , 33n) included in the monitoring system 1 is n (n being 2 or more) is described, but the number of sensors 33 may be freely chosen.

The server apparatus 10 controls the camera 31 so that periodically (for example, once to several times a day), the camera 31 automatically conducts a camera patrol inside the target facility according to predefined procedures. The time required for one camera patrol may, for example, be set from several minutes to several tens of minutes, like a patrol by a security guard, or may be even longer. In a case in which there is a plurality of cameras 31, a single camera patrol may be performed by the plurality of cameras 31 working together to capture a series of images. The camera 31 may continue to capture images while sequentially switching the angle of view, orientation, and the like by controlling the PTZ values, even during the time when the camera patrol is not being conducted. The microphone 32 and the sensors 33 may operate so as to continuously detect signals regardless of whether the camera patrol is being conducted.

In such a configuration, the monitoring system 1 not only displays the video being captured by the camera 31 in conducting a camera patrol, but also displays images for checking events and the like that occurred between the end of the previous patrol and the start of the current patrol. Specifically, for example, the monitoring system 1 may be able to display live video, which is the video of the current conditions captured by the camera 31 at each point in the automatic patrol, together with edited video yielded by editing, such as fast-forwarding the recorded video of the camera 31 at the relevant points between the previous patrol and the current patrol. Furthermore, for example, the monitoring system 1 may simultaneously display an image that includes the event history of the relevant points as generated by the sensors 33, such as door open/close sensors and human detection sensors, along with a graph of the values of physical quantities, such as temperature, humidity, and CO2 concentration, measured by the sensors 33. According to this configuration, the user can easily grasp the conditions at the relevant points during the period between the previous patrol and the current patrol and can easily recognize when an anomaly has occurred. In addition, the user can recognize problems from events that have occurred at the location since the previous patrol, and based on the results, can modify the points to check when checking the current video. Therefore, according to the monitoring system 1, users can be prevented from overlooking problems that are hidden in the current video. By the edited video of the video since the previous patrol and an image of the information acquired by the sensors 33 thus being displayed in addition to the video captured by the current patrol, it becomes easier to detect and prevent anomalies that are difficult to deal with during a patrol by a guard.

Furthermore, the monitoring system 1 may automatically generate a report (including electronic document data) that includes the results of the patrol, video information from the previous patrol to the current patrol, an event history, a graph of numerical information on physical quantities, and the like. This enables the user of the monitoring system 1 to easily acquire a report document of the patrol results, including events and the like that occurred during the patrol.

### Server Apparatus

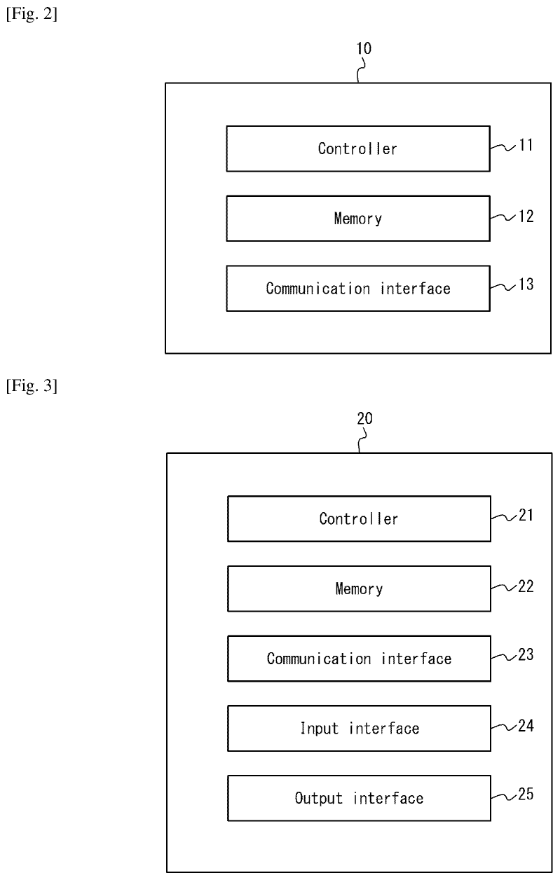

FIG. 2 is a diagram illustrating an example hardware configuration of the server apparatus 10 in FIG. 1. The server apparatus 10 is one computer or a plurality of communicably connected computers. The server apparatus 10 is realized by a general purpose computer such as a personal computer (PC) or workstation (WS), but may also be realized by a field programmable gate array (FPGA) or the like. As illustrated in FIG. 2, the server apparatus 10 includes a controller 11, a memory 12, and a communication interface 13.

The controller 11 includes one or more processors. The “processor” in an embodiment is a general purpose processor or a dedicated processor specialized for particular processing, but these examples are not limiting. The controller 11 is communicably connected with each component of the server apparatus 10 and controls operations of the server apparatus 10 overall.

The memory 12 includes any appropriate memory module, such as a hard disk drive (HDD), a solid state drive (SSD), read-only memory (ROM), and random access memory (RAM). The memory 12 may, for example, function as a main memory, an auxiliary memory, or a cache memory. The memory 12 stores any information used for operations of the server apparatus 10. For example, the memory 12 may store system programs (operating system), application programs, various types of information received by the communication interface 13, and the like. The memory 12 is not limited to being internal to the server apparatus 10 and may be an external database or an external memory module.

The communication interface 13 includes any appropriate communication module capable of connecting and communicating with other apparatuses, such as the camera 31, the microphone 32, the sensors 33, and the client apparatus 20, by any appropriate communication technology. The communication interface 13 may further include a communication control module for controlling communication with other apparatuses and a memory module for storing communication data, such as identification information, necessary for communicating with other apparatuses.

The signal processor 101 and the communication controller 102, which are the functional elements of the server apparatus 10, can be realized by the processor included in the controller 11 executing a computer program (program) according to the present embodiment. That is, the functional elements of the server apparatus 10 can be realized by software. The computer program causes a computer to execute the processing of the steps included in the operations of the server apparatus 10 to implement the functions corresponding to the processing of the steps. That is, the computer program is a program for causing a computer to function as the server apparatus 10 according to the present embodiment. The computer program may be recorded on a computer readable recording medium. Examples of the program include an equivalent to the program represented as information provided for processing by an electronic computer. For example, data that is not a direct command for a computer but that has the property of specifying processing by the computer corresponds to the “equivalent to the program”.

A portion or all of the functions of the server apparatus 10 may be implemented by a dedicated circuit included in the controller 11. In other words, a portion or all of the functions of the server apparatus 10 may be implemented by hardware. Furthermore, the server apparatus 10 may be implemented by a single computer or implemented by cooperation among a plurality of computers.

### Client Apparatus

FIG. 3 is a diagram illustrating an example hardware configuration of the client apparatus 20 in FIG. 1. The client apparatus 20 is one computer or a plurality of communicably connected computers. The client apparatus 20 is realized by a general purpose computer such as a PC or tablet terminal, but may also be realized by an FPGA or the like. As illustrated in FIG. 3, the client apparatus 20 includes a controller 21, a memory 22, a communication interface 23, an input interface 24, and an output interface 25.

The hardware configuration of the controller 21, the memory 22, and the communication interface 23 are realized in the same way as the controller 11, the memory 12, and the communication interface 13 of the server apparatus 10. Hence, a detailed description is omitted.

The input interface 24 includes one or more input interfaces that receive a user input operation and acquire input information based on the user operation. For example, the input interface 24 may be physical keys, capacitive keys, a pointing device, a touchscreen integrally provided with a display of the output interface 25, a microphone that receives audio input, or the like, but is not limited to these.

The output interface 25 includes one or more output interfaces that output information to the user to notify the user. For example, the output interface 25 may be a display that outputs information as images, a speaker that outputs information as sound, or the like, but these examples are not limiting. Such a display may, for example, be a liquid crystal panel display or an organic electroluminescent (EL) display. The input interface 24 and/or the output interface 25 described above may be formed integrally with the client apparatus 20 or be provided separately.

Like the server apparatus 10, the functional elements of the client apparatus 20, i.e., the patrol controller 201, the display controller 202, and the communication controller 203, can be realized by the processor included in the controller 21 executing a program according to the present embodiment.

### Sensors

The sensors 33 may include a detection apparatus that detects the occurrence of a predetermined event and a measurement apparatus that measures a predetermined physical quantity. The predetermined events that the detection apparatus detects the occurrence of is an event that has relevance to phenomena that should be noted during a camera patrol in terms of security or crime prevention. For example, the detection apparatus may be a door open/close sensor, a human detection sensor, an intrusion detection sensor, a fire sensor, or a smoke sensor. The measurement apparatus may, for example, be a temperature sensor, a humidity sensor, a CO₂ concentration sensor, an illuminance sensor, or a traffic sensor. The detection apparatus may detect, as an event, that a physical quantity such as temperature, humidity, CO₂ concentration, illuminance, or traffic measured by the measurement apparatus has become larger or smaller than a predetermined threshold.

A “door open/close sensor” is a sensor that, for example, detects the opening and closing of a door at the entrance or exit of a building, the entrance or exit of a room, or the like. The door open/close sensor may, for example, be configured as a switch attached to a door and mechanically linked to the open/close state of the door. The door open/close sensor may output a signal indicating the opening or closing of the door to the server apparatus 10.

A “human detection sensor” is a sensor that detects whether a person is present at a particular location. The human detection sensor may, for example, be configured as an infrared sensor that detects infrared radiation emitted by a person. The human detection sensor may output a signal indicating the presence or absence of a human to the server apparatus 10. The human detection sensor continuously detects for a certain period of time, and therefore if the detected state continues once a human has been detected, the human detection sensor may transmit the result of detection to the server apparatus 10 at regular intervals.

An “intrusion detection sensor” is a sensor that detects the intrusion of a person or other obstacle into a particular location. The intrusion detection sensor may, for example, be configured as a sensor that detects when an obstacle passes between an apparatus that emits infrared radiation and an apparatus that receives infrared radiation, a sensor that detects a pattern of vibration when window glass is broken, or the like. When intrusion by an obstacle is detected, the intrusion detection sensor may output a signal indicating the intrusion to the server apparatus 10. The door open/close sensor, human detection sensor, and intrusion detection sensor may be realized by motion sensors that detect the motion of some object in the area to be monitored.

A “fire sensor” is a sensor that detects the outbreak of fire. The fire sensor may, for example, be configured as a smoke sensor that detects smoke or a heat sensor that detects heat. When a fire is detected, the fire sensor may output a signal indicating the fire to the server apparatus 10 as a detection result. When smoke is detected, the smoke sensor may output a signal indicating the smoke to the server apparatus 10.

A “temperature sensor” is a sensor that detects the temperature of a particular object. The temperature sensor may, for example, be configured as a sensor using a thermocouple or a sensor using the change in resistance of an object due to temperature (for example, a thermistor). The temperature sensor may output a signal indicating the numerical value of the detected temperature to the server apparatus 10.

A “humidity sensor” is a sensor that detects the humidity in a target space. The humidity sensor may, for example, be configured as a resistive sensor or a capacitive sensor. The humidity sensor may output a signal indicating the numerical value of the detected humidity to the server apparatus 10.

A “CO₂ concentration sensor” is a sensor that detects the concentration of CO₂ in a target space. The CO₂ concentration sensor may, for example, be configured as a Non Dispersive InfraRed (NDIR) type sensor using the infrared absorption property of CO₂. The CO₂ concentration sensor may output a signal indicating the numerical value of the detected CO₂ concentration to the server apparatus 10.

An “illuminance sensor” is a sensor that detects the illuminance in a target space. The illuminance sensor may, for example, be configured as a sensor that measures the intensity of light received by a photodiode, a phototransistor, or the like. The illuminance sensor may output a signal indicating the numerical value of the detected illuminance to the server apparatus 10.

A “traffic sensor” is a sensor that counts the amount of traffic of people, vehicles, or the like. The traffic sensor may, for example, be realized by an infrared sensor that detects when a person, vehicle, or the like passes between an infrared transmitter and receiver and blocks an infrared beam. For example, two pairs of infrared sensors may be installed to detect the amount of traffic by identifying the direction of traffic according to which infrared beam was blocked first.

According to detection of an event and the measurement of a physical quantity, the sensors 33 thus transmit information, such as the detected event type and time, the measured value of the physical quantity, and the like, to the server apparatus 10.

The above-described door open/close sensor, human detection sensor, intrusion detection sensor, fire sensor, smoke sensor, temperature sensor, humidity sensor, CO2 concentration sensor, illuminance sensor, and traffic sensor are examples of the sensors 33. The sensors 33 may be devices that detect other information. Also, the configurations of the above-described door open/close sensor, human detection sensor, intrusion detection sensor, fire sensor, smoke sensor, temperature sensor, humidity sensor, CO₂ concentration sensor, illuminance sensor, and traffic sensor are examples. These sensors may be configured as other types of sensors.

### Operations of Monitoring System

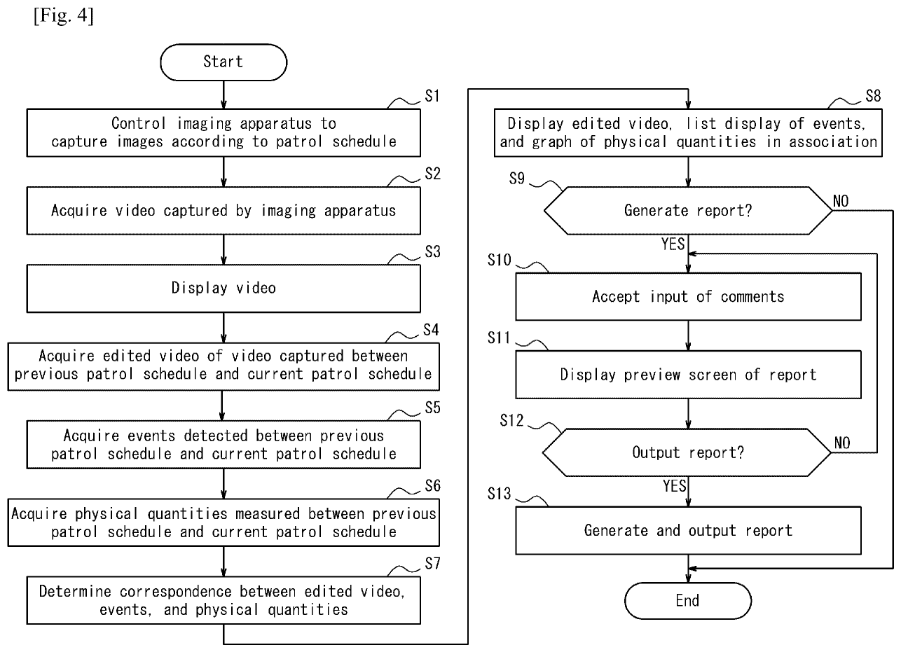

FIG. 4 is a flowchart illustrating an example of operations by the monitoring system 1 according to an embodiment. The operations of the monitoring system 1 described with reference to FIG. 4 can correspond to one control method of an information processing apparatus. The operations of each step in FIG. 4 can be performed based on control by the controller 11 of the server apparatus 10. Each of the following steps is executed for each patrol schedule of the monitoring system 1.

In step S1, the controller 11 controls the camera 31 (imaging apparatus) to capture images in a fixed imaging range according to a preset patrol schedule.

In step S2, the controller 11 acquires the video captured by the camera 31 according to the current patrol schedule in step S1 as a live video.

In step S3, the controller 11 displays the video acquired in step S2 as a live video on the display. Specifically, the controller 11 may transmit the video acquired in step S2 to the client apparatus 20 and display the video on the display of the output interface 25 of the client apparatus 20.

The controller 11 may execute steps S1-S3 and steps S4-S8 in parallel or may execute steps S4-S8 before the processing in steps S1-S3.

In step S4, the controller 11 acquires an edited video of the video captured between the previous patrol schedule (first patrol schedule) and the current patrol schedule (second patrol schedule). The edited video is a video generated by editing a recorded video, which is the video captured by the camera 31 between the end of the previous patrol schedule and the start of the current patrol schedule. For example, the controller 11 may acquire, as the edited video, a video generated by playing back the recorded video from the previous patrol schedule to the current patrol schedule in fast-forward at a constant speed. Other examples of the edited video are described below in the explanation of step S8.

In step S5, the controller 11 acquires the events detected by the microphone 32 or the sensors 33 between the previous patrol schedule and the current patrol schedule. For example, the controller 11 may acquire information including the time (date and time) of occurrence, type, priority, location, and the like of each of the detected events.

In step S6, the controller 11 acquires the physical quantities measured by the microphone 32 or the sensors 33 between the previous patrol schedule and the current patrol schedule. For example, the controller 11 may acquire information indicating the change over time in the measured physical quantity.

In step S7, the controller 11 determines the correspondence between the edited video, events, and physical quantities acquired in steps S4-S7. For example, the controller 11 may determine the correspondence based on factors such as the time at which the event was detected.

In step S8, the controller 11 displays the edited video, a list display of detected events, and a graph of physical quantities in association on the display. Specifically, the controller 11 may transmit the edited video, the list display of detected events, and the graph of physical quantities to the client apparatus 20 and display these on the display of the output interface 25 of the client apparatus 20.

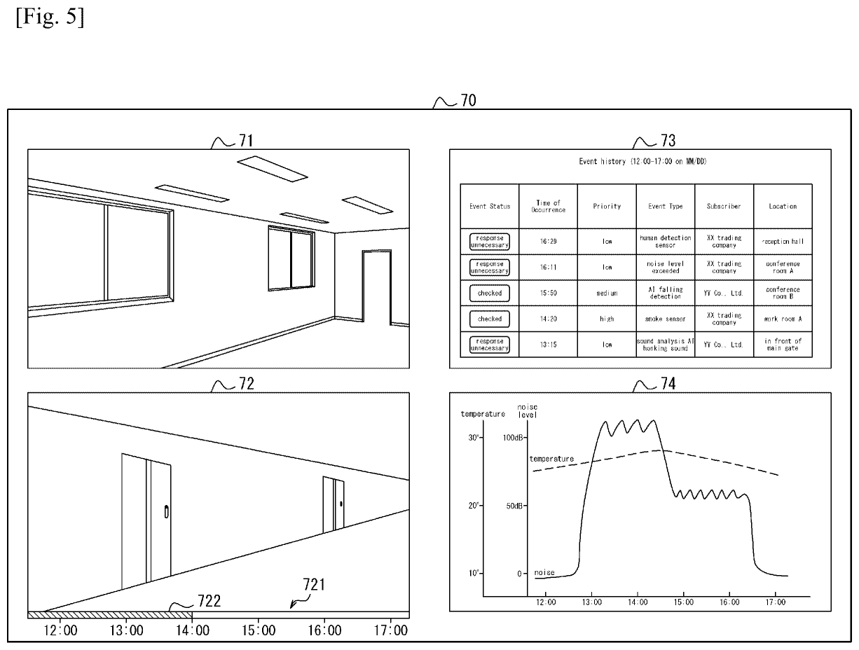

FIG. 5 is a diagram illustrating an example screen 70 displayed on the client apparatus 20. The screen 70 includes areas 71-74.

The area 71 is an area for displaying the live video, which is the video being acquired by capturing images during the current patrol schedule. Upon receiving the captured video from the camera 31, the controller 11 may sequentially transmit the video to the client apparatus 20 and display the video on the output interface 25 in real time.

The area 72 is an area for displaying the edited video of the video captured by the camera 31 between the end of the previous patrol schedule and the current patrol schedule. For example, the controller 11 may display a simple fast-forward video (for example, a timelapse image) of the recorded video, which is the video captured between the end of the previous patrol schedule and the current patrol schedule, in the area 72 as the edited video. Alternatively, the controller 11 may, for example, analyze the recorded video captured between the end of the previous patrol schedule and the current patrol schedule, extract video in the time range when some sort of motion occurred within the whole screen, and display a compilation of the extracted video in the area 72 as the edited video.

Alternatively, the controller 11 may, for example, analyze the recorded video captured between the end of the previous patrol schedule and the current patrol schedule, extract video in the time range when some sort of motion occurred in a particular portion of the screen, and display a compilation of the extracted video in the area 72 as the edited video. Such processing can, for example, be performed in the same way as Video Management System (VMS) software that processes video of a surveillance camera and controls recording. Specifically, the controller 11 may, for example, establish a grid of delimiters in the recorded video, and if a difference exists between adjacent frames in the grid corresponding to a particular portion, the controller 11 may detect that motion has occurred at that location. In a case in which motion is detected in such a grid, the controller 11 may retain information such as the time at which the motion was detected as meta information in a recording file. The controller 11 may identify the time at which the motion was detected by referring to the meta information, extract the video that was captured within a certain time range before and after the time, and display a compilation of extracted video in the area 72 as the edited video.

The controller 11 thus displays, side by side, not only live video but also an edited video of the recorded video between the end of the previous patrol schedule and the current patrol schedule. Therefore, in a short amount of time the user, such as a guard, can check not only anomalies that are currently occurring at the monitored location, but also anomalies that have occurred at the monitored location between the check during the previous patrol schedule and the current patrol schedule. In addition, even if there is a difference in the live video during the current patrol compared to the live video in the previous patrol, the user can grasp the cause and circumstances of the difference by use of the edited video and determine whether the difference indicates an anomaly. According to the controller 11, detection of anomalies in monitoring systems can thereby be facilitated.

The controller 11 also acquires and displays, as the edited video, a video generated by playing back the recorded video in fast-forward at a constant speed or a video that continuously plays back video of a portion in which motion is detected in the recorded video. Therefore, the user can check the current video while referring to the edited video, in particular to the video that was captured between the end of the previous patrol schedule and the start of the current patrol schedule and requires attention. The user can thus detect anomalies more easily.

Alternatively, the controller 11 may, for example, extract the recorded video that was captured within a certain time range before and after the time of occurrence of the events acquired in step S5, and display a compilation of extracted video in the area 72. The controller 11 may, for example, display a compilation of a video of the time range when some sort of motion occurred within the whole screen or in a particular portion of the recorded video, a video before and after the time of occurrence of the events, and the like in the area 72 as the edited video. Alternatively, the controller 11 may, for example, display a compilation of frame images of the recorded video at the time of occurrence of the events in the area 72 as the edited video.

The controller 11 thus acquires and displays, as edited images, a video that continuously plays back a portion of the recorded video corresponding to the time of occurrence of events. Therefore, the user can refer to the edited video corresponding to the detected events to check, in greater detail, the anomalies caused by the events that occurred.

In the example in FIG. 5, the controller 11 displays an image 721 indicating the temporal position of the currently displayed edited video. The image 721 indicates the temporal position of the currently playing edited video by an indicator 722 on a time bar. The user can therefore easily check the time of the currently displayed edited video.

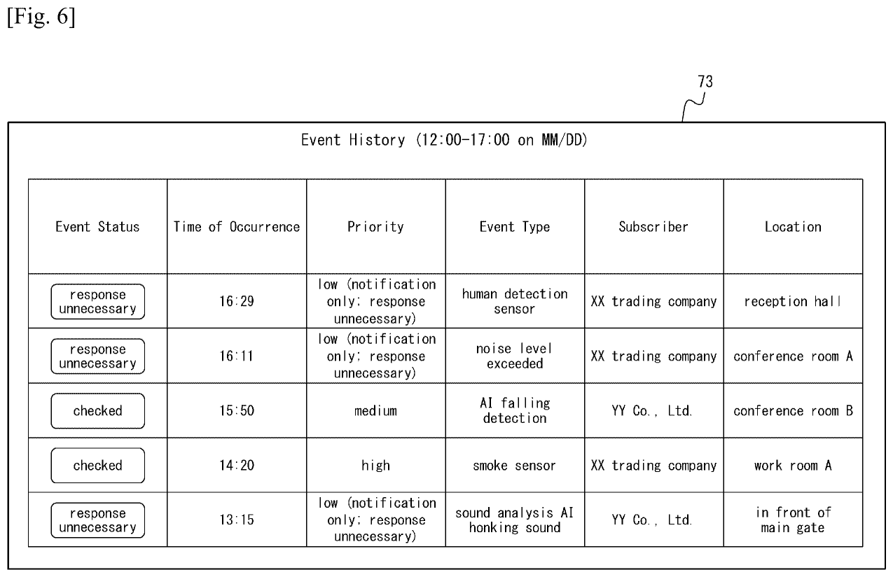

The area 73 is an area that displays a list of the events detected by the microphone 32 or the sensors 33 between the previous patrol schedule and the current patrol schedule. FIG. 6 is a diagram illustrating an example screen displayed in the area 73 in FIG. 5. The area 73 lists the events that occurred between “12:00-17:00 on MM/DD”. In FIG. 6, the “Event Status” indicates whether a response to the detected event is required, whether the event has been confirmed, and the like. The “Time of Occurrence” indicates the time when the event was detected. The “Priority” indicates the priority for responding to the event. The “Event Type” indicates the type of sensor 33 that detected the event. The “Subscriber” indicates the subscriber of the monitoring service (for example, the manager of the target facility). The “Location” indicates the location where the event was detected.

For example, when a door open/close sensor, human detection sensor, intrusion detection sensor, fire sensor, or the like detects an event, the manager of the target facility may respond to the event detection by immediately notifying the server apparatus 10 or the like of an alarm or by outputting an alarm sound. When such a response is made to event detection, the controller 11 may display in the “Event Status” that a response has been made. By such indication of the detection of events even for which a response has been made, the user may conduct a patrol while keeping in mind the occurrence of important events such as intrusion or a fire during the patrol schedule. Furthermore, in addition to such events that are clearly problematic, the controller 11 also displays the time of occurrence, event type, and the like for events that were not treated as problematic, as in FIG. 6. This enables the user to easily determine whether an event detected during a patrol was actually not a problem by checking the video displayed in the area 71 in the patrol schedule while paying attention to the event.

The controller 11 displays the detected events in order of “time of occurrence” but may sort and display the events according to a selection of other items such as “priority” and “event type”. The controller 11 may also display the detected events for each of the sensors 33 in order of “time of occurrence”. The controller 11 may also display information on an event by adjusting the color, font, or the like according to the type of sensor 33 that detected the event.

The controller 11 thus displays, together with the live video and the edited video, a list image that is an image including a list display of the time of occurrence and the type of each detected event between the end of the previous patrol schedule and the start of the current patrol schedule. Therefore, the user can check the current live video while recognizing the time of occurrence, type, and the like of events and can more easily detect anomalies that have occurred between the previous patrol schedule and the present.

The physical quantities, such as temperature, humidity, CO2 concentration, illuminance, or traffic measured by the sensors 33 are displayed as a graph in the area 74, but the controller 11 may consider these physical quantities having become larger or smaller than a predetermined threshold as an event and display a list of the events in the area 73. For example, when the temperature exceeds a certain temperature, when the CO2 concentration exceeds a certain concentration, when the number of people or vehicles passing through per unit time exceeds a threshold, or when the number of people present exceeds a threshold, the controller 11 may display these as events in the area 73. Alternatively, the controller 11 may consider the range of change in these physical quantities having become larger than a predetermined threshold as an event and display a list of the events in the area 73. This enables the user to easily recognize physical quantities that particularly need to be checked.

The controller 11 thus displays events determined based on the measured physical quantities in the list image, enabling the user to check, in the list image, not only the events detected by the detection apparatus but also the events determined based on the physical quantities.

The controller 11 may also analyze the recorded video captured by the camera 31 between the end of the previous patrol schedule and the current patrol schedule and detect the presence of people, objects, or the like and particular phenomena as events. The controller 11 may display a list of information about these events in the area 73. Specifically, the controller 11 may, for example, detect the appearance of a person, equipment, animal, vehicle, special vehicle, or material in the video as an event using known machine learning methods. Specifically, for example, the controller 11 may define a particular area in the screen and detect an event representing intrusion into the area in a case in which a person, vehicle, or the like is recognized as having entered the area. Alternatively, the controller 11 may, for example, detect certain actions by a person, such as a person falling, violence, or theft, using known machine learning methods. When detecting an event by analyzing the recorded video captured by the camera 31 between the end of the previous patrol schedule and the current patrol schedule, the controller 11 may use information detected by the microphone 32 and the sensors 33 in addition to information on the video.

The controller 11 may also analyze the audio acquired by the microphone 32 between the end of the previous patrol schedule and the current patrol schedule, detect the audio as an event, and display a list of the detected events in the area 73. For example, the controller 11 may detect events by applying a known machine learning analysis to the audio collected by the microphone 32 installed at each patrol location or a built-in microphone of the camera 31. For example, the controller 11 may detect as an event a person's shout (scream, yell, or the like), a person's footsteps (walking, running, or the like), or a conversation with a certain tone of voice or a hitting sound that may indicate a violent act such as a fight. Alternatively, the controller 11 may, for example, extract sounds of hitting or breaking objects, unusual noises emitted by apparatuses operating at the location, vehicle collision sounds, sudden braking sounds, honking, car crash noises, animal noises, animal footsteps, and the like and detect these as events. Upon recognizing such sounds, the controller 11 may display a list in the area 73 indicating, for example, the type of shouting, footsteps, or violent behavior.

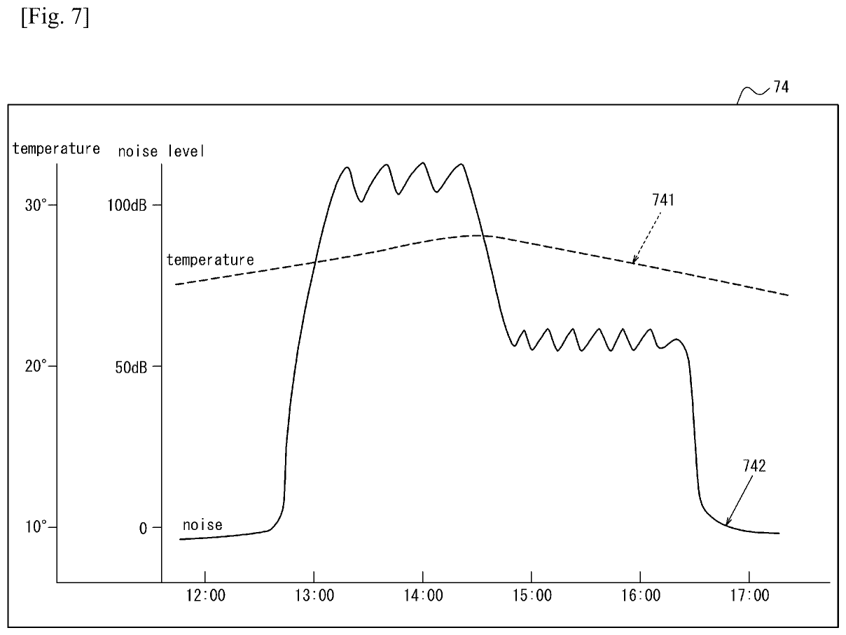

The area 74 is an area that displays a graph illustrating the change over time in the physical quantities measured by the microphone 32 or the sensor 33 between the previous patrol schedule and the current patrol schedule. FIG. 7 is a diagram illustrating an example screen displayed in the area 74 in FIG. 5. FIG. 7 illustrates an example of a graph 741 of the change in temperature over time and a graph 742 of the change in noise level over time.

In addition to the above-described change over time in the physical quantities measured by the sensors 33, the controller 11 may also analyze the recorded video captured by the camera 31 and display, in the area 74, the change over time in quantities detected based on the result of analysis. For example, the controller 11 may use known machine learning methods to analyze the video captured by the camera 31 between the end of the previous patrol schedule and the current patrol schedule and detect people, vehicles, and the like in the video. Based on the result of such detection, the controller 11 may acquire the change over time in the number of people passing by, the number of vehicles passing by, the number of people present, the number of vehicles present, and the like at a particular location. Specifically, the controller 11 may, for example, detect the passage of people or vehicles by how a detected person, vehicle, or the like has passed a line set within the screen and by the direction of passage. Alternatively, the controller 11 may, for example, detect the number of people, vehicles, or the like present in a particular area by calculating the number of people, vehicles, or the like existing in the area, or by calculating the difference between the numbers that go in and out at the entrance and exit of the area. The controller 11 may display a graph in the area 74 illustrating the change over time in the quantities thus acquired.

In this way, the monitoring system 1 simultaneously displays, on the screen displaying the video of the camera 31 that the user views in the automatic patrol, the edited video of the video captured by the camera 31, the history of events detected by the sensors 33 and the like, and a graph based on numerical data continuously measured by the sensors 33, from between the previous patrol and the timing of the current patrol. Therefore, according to the monitoring system 1, when there is an anomalous change in a physical quantity, for example, the user can recognize the change by comparison with the edited video and the list image and can check the current live video. In addition, since the user can recognize the points to focus on when patrolling, the user can easily perform monitoring with a higher level of security. The user can therefore detect anomalies more easily.

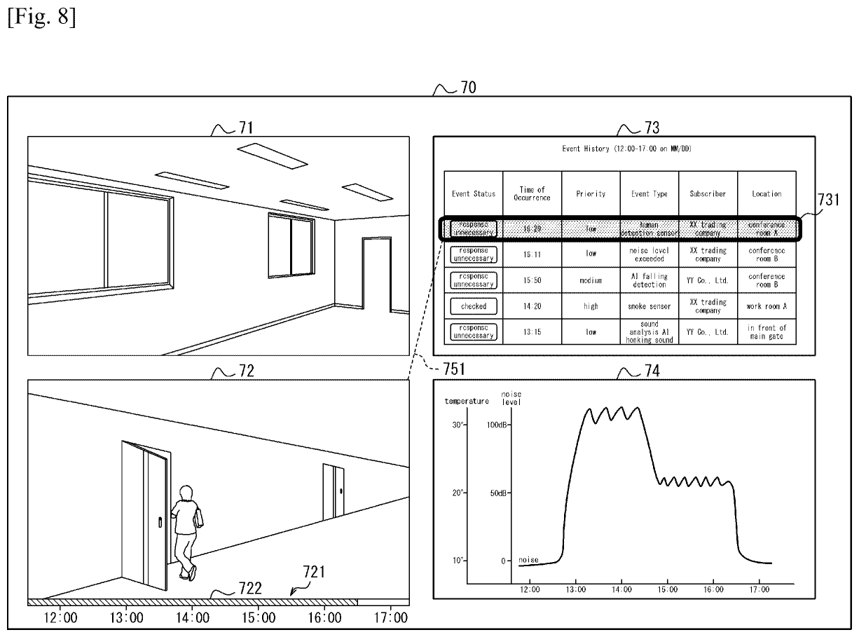

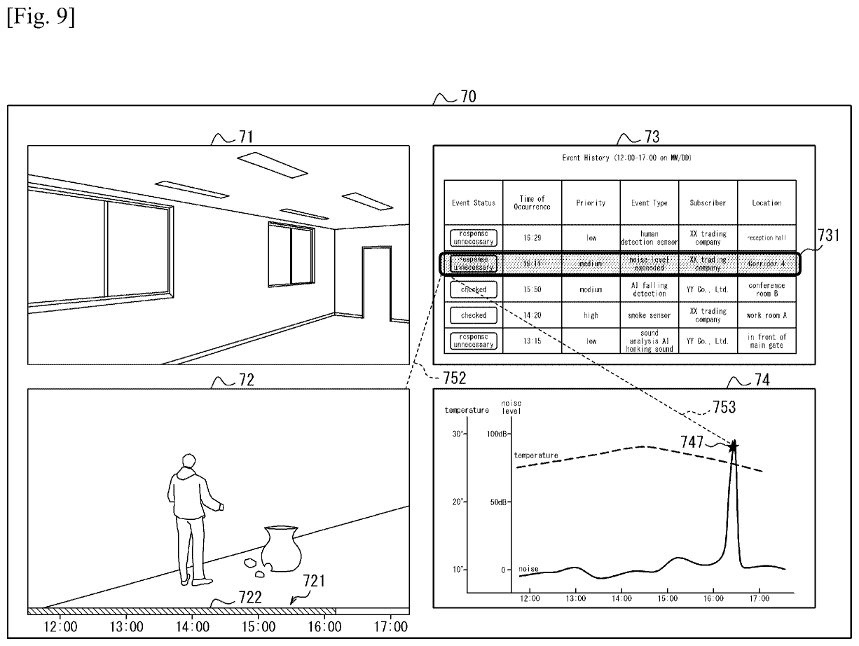

The controller 11 may display the images displayed in areas 72-74 based on the same event in association with each other. FIGS. 8 and 9 are diagrams illustrating example screens displayed on the client apparatus 20.

FIG. 8 illustrates how the list display of events in the area 73 is displayed in association with the edited video in the area 72 based on an event in which the human detection sensor detected a person. As described above, in a case in which the sensor 33 detects a particular event, the controller 11 may generate the edited video by extracting the video captured by the camera 31 in a certain time range including the time at which the event was detected. Therefore, when playing back the edited video in the area 72, the controller 11 may display, via an image 751, the correspondence with information 731 of the corresponding event displayed in the list in the area 73 while displaying the portion before and after such an event. The controller 11 may highlight the information 731 of the corresponding event displayed in the list in the area 73 by changing the color or the text size. In displaying the edited video corresponding to the information 731 of the event in the area 72, the controller 11 may highlight by, for example, enclosing the entire information 731 with a frame. Furthermore, the controller 11 may display the corresponding edited video in the area 72 along with the image 751 in response to the user selecting the information 731 of the event in the area 73.

The controller 11 thus highlights the event corresponding to the currently displayed edited video in the list image (for example, the information 731). The user can thereby more easily recognize the event corresponding to the currently displayed edited video. In addition, when simultaneously displaying the live video, the edited image, and the list image, the controller 11 further displays an image (such as the image 751, or the image 752 described below) indicating the correspondence between the event highlighted in the list image and the edited video. Therefore, the user can more easily recognize the correspondence between the content of the currently displayed edited video and the detected event.

FIG. 9 illustrates how, based on the detection by the microphone 32 of audio at a level greater than a certain threshold, the following are displayed in association: edited video of the corresponding event in the area 72, information on the event listed in the area 73, and a graph displayed in the area 74. In the example in FIG. 9, at around time 16:11, noise exceeding a certain audio level is detected as an event. In the area 74, a point corresponding to that event is indicated by an image 747 as an event image in the graph 743 of the noise level. An event image is an image that indicates the occurrence of an event on the graph. In the example in FIG. 9, the image 747 is a star, but the event image can be an image with any shape other than a star. For example, the event image may be an arrow, a predetermined mark, a design (such as an icon), or a text display. The information 731 of the event is highlighted in the area 73. The video at the time of the event is displayed in the area 72. The controller 11 indicates, with the images 752, 753, the correspondence between the edited video in the area 72, the information 731 on an event in the area 73, and the image 747 indicating the peak of the graph 743 in the area 74.

The controller 11 thus determines that an event has occurred by the measured physical quantity satisfying a predetermined condition and displays an event image (for example, the image 747) indicating the occurrence of the event at a position on the graph corresponding to the time and physical quantity of the determined event. Therefore, the user can easily recognize the time, physical quantity, and the like in the graph for the event that occurred. Here, the controller 11 may determine that an event has occurred by satisfaction of a predetermined condition in a case in which the measured value of the physical quantity or the amount of change in the measured value exceeds a predetermined threshold value. Alternatively, when the measured value of a physical quantity or the amount of change in the measured value exhibits a regular change according to the time, day of the week, season, or the like, a range of tolerable deviation from the regular periodic change can be defined in advance. In this case, the controller 11 may determine that an event has occurred in a case in which the deviation exceeds the range. When simultaneously displaying the live video, the edited video, the list image of events, and the graph of the physical quantity, the controller 11 further displays an image (for example, the image 753) indicating the correspondence between the event image (for example, the image 747) on the graph and the display of the event in the list image. Therefore, the user can more easily recognize the correspondence between the graph of the physical quantity and the event displayed in the list image.

The description now returns to FIG. 4. In step S9, the controller 11 determines whether to generate a report (report document). For example, the controller 11 may determine to generate a report in a case in which the user of the client apparatus 20 instructs to generate the report. In the case of generating the report (YES in step S9), the controller 11 proceeds to step S10, whereas otherwise (NO in step S9), the controller 11 terminates the process of the flowchart.

In step S10, the controller 11 accepts input from the user of comments to be included in the report. For example, a text input screen may be displayed, and comments may be accepted via the input screen.

In step S11, the controller 11 displays a preview screen of the report. The controller 11 may generate the preview screen of the report based on the images in the areas 71-74 displayed on the screen 70 and the comments entered in step S10.

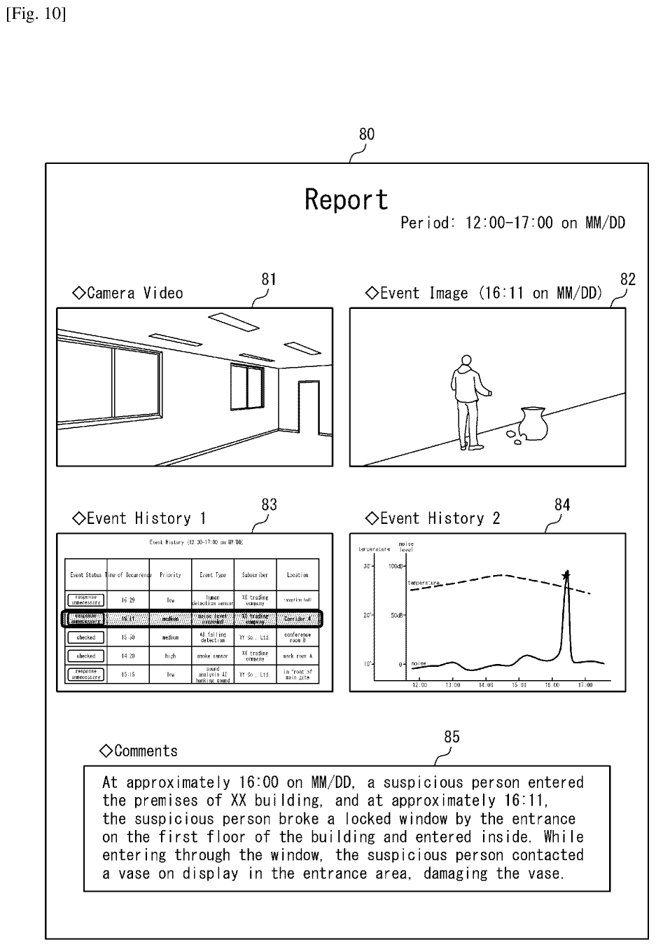

FIG. 10 is a diagram illustrating an example of a preview screen of a report document generated by the monitoring system 1. In FIG. 10, a preview screen 80 of the report includes areas 81-85. The area 81 displays a representative image from the video of the camera 31. The area 82 displays an image captured by the camera 31 when the event was detected. The area 83 displays an image with a list display of events. The area 84 displays a graph illustrating the change over time in physical quantities. The area 85 displays a comment entered by the user. The following comment has been entered in the example illustrated in FIG. 10: “At approximately 16:00 on MM/DD, a suspicious person entered the premises of XX building, and at approximately 16:11, the suspicious person broke a locked window by the entrance on the first floor of the building and entered inside. While entering through the window, the suspicious person contacted a vase on display in the entrance area, damaging the vase.” The user checks such a preview screen 80 and determines whether to output the report indicated by the preview screen 80.

In the process of generating a report, the controller 11 may accept a user's selection of the content to be included in the report, for example regarding the recorded video, sensor measurements, and events since the patrol. For example, the user may accept editing of the content to be displayed in the report through operations on the areas 81-85 on the preview screen 80.

In step S12, the controller 11 determines whether to output the report. For example, the controller 11 may determine whether to output the report based on whether the user has instructed to output the report. In the case of outputting the report (YES in step S12), the controller 11 proceeds to step S13, whereas otherwise (NO in step S12), the controller 11 proceeds to step S10 to further accept editing of comments and the like.

In step S13, the controller 11 outputs the report confirmed by the user via the preview screen 80. For example, the controller 11 may output the report as a file in a specific format such as Portable Document Format (PDF) or output a report printed from a printer onto a recording medium. After completing the process of step S13, the controller 11 ends the process of the flowchart.

As described above, the server apparatus 10 is an information processing apparatus that can communicate with the camera 31, which captures video. The server apparatus 10 controls the camera 31 to capture images in a fixed imaging range according to a preset patrol schedule. The server apparatus 10 acquires an edited video of recorded video captured between the end of a first patrol schedule (previous patrol schedule) and the start of a second patrol schedule (current patrol schedule), which is the next patrol schedule after the first patrol schedule. The server apparatus 10 acquires a live video that is video in the imaging range captured by the camera 31 according to the second patrol schedule. The server apparatus 10 displays the live video and the edited video on the output interface 25 (display) of the client apparatus 20.

Therefore, the user can refer to the live video while checking the edited video between the end of the first patrol schedule and the start of the second patrol schedule. Therefore, in a short amount of time, the user can find not only anomalies that are currently occurring at the monitored location, but also anomalies that have occurred at the monitored location between the check during the previous patrol schedule and the current patrol schedule. In addition, even if there is a difference in the live video during the current patrol compared to the live video in the previous patrol, the user can grasp the cause and circumstances of the difference by use of the edited video and determine whether the difference indicates an anomaly. For example, the user can focus on checking for items such as objects left behind or intentionally placed eavesdropping devices during the current patrol based on knowledge of the locations where people or objects have moved or have entered/exited since the previous patrol, thereby increasing the probability of finding such items.

The server apparatus 10 also displays, together with the live video and the edited video, a list image of detected events and a graph of measured physical quantities. Therefore, at the time for checking, the user can focus on checking locations at which environmental changes, such as temperature, humidity, noise level, or CO₂ concentration, do not coincide with factors of environmental change, such as an increase in the number of people. This can further help to prevent security oversights and the like. In addition, the user can, for example, compare the video captured during the previous patrol with the video captured during the current patrol. In the case of a difference between the two videos, the user can ascertain whether the difference indicates an abnormal situation or whether the difference was reasonably caused by what occurred during the period from the last patrol to the current one, thereby improving the accuracy of determining whether a situation is abnormal or normal.

In displaying video for the user during the camera 31 patrol, the monitoring system 1 thus simultaneously displays, in addition to the current video captured by the camera 31, video yielded by fast-forwarding the video captured between the previous patrol and the current patrol, an event history detected by the sensors 33, numerical data outputted by the sensors 33, and the like. This enables more advanced security monitoring by the user.

The present disclosure is not limited to the above embodiments. For example, a plurality of blocks described in the block diagrams may be integrated, or a block may be divided. Instead of a plurality of steps described in the flowcharts being executed in chronological order in accordance with the description, the plurality of steps may be executed in parallel or in a different order according to the processing capability of the apparatus that executes each step, or as required. Other modifications can be made without departing from the spirit of the present disclosure.

### REFERENCE SIGNS LIST

1 Monitoring system
10 Server apparatus
11 Controller
12 Memory
13 Communication interface
101 Signal processor
102 Communication controller
20 Client apparatus
21 Controller
22 Memory
23 Communication interface
24 Input interface
25 Output interface
201 Patrol controller
202 Display controller
203 Communication controller
31 Camera
32 Microphone
33 Sensor
70 Screen
71-74 Display area

1. An information processing apparatus capable of communicating with an imaging apparatus that captures video composed of a plurality of frame images, the information processing apparatus comprising a controller configured to:
control the imaging apparatus to capture images in a fixed imaging range according to a preset patrol schedule;
acquire an edited video generated by editing a recorded video that is a video captured by the imaging apparatus between an end of a first patrol schedule and a start of a second patrol schedule, which is a next patrol schedule after the first patrol schedule;
acquire a live video that is video captured by the imaging apparatus according to the second patrol schedule; and
display the live video and the edited video on a display.

2. The information processing apparatus according to claim 1, wherein the controller is configured to acquire, as the edited video, a video generated by playing back the recorded video in fast-forward at a constant speed over a period from the end of the first patrol schedule to the start of the second patrol schedule, or a video that continuously plays back video of a portion in which motion is detected in the recorded video.

3. The information processing apparatus according to claim 1, wherein
the information processing apparatus is capable of communicating with a detection apparatus that detects an occurrence of a predetermined event, and
the controller is configured to
acquire information including a time of occurrence and a type of each event detected by the detection apparatus between the end of the first patrol schedule and the start of the second patrol schedule, and
further display, on the display, a list image that is an image including a list display of the time of occurrence and the type of each event detected by the detection apparatus between the end of the first patrol schedule and the start of the second patrol schedule.

4. The information processing apparatus according to claim 3, wherein the controller is configured to acquire, as the edited video, a video that continuously plays back a portion of the recorded video corresponding to the time of occurrence of the event detected by the detection apparatus.

5. The information processing apparatus according to claim 4, wherein the controller is configured to highlight, in the list image, the event corresponding to the edited video displayed on the display.

6. The information processing apparatus according to claim 5, wherein the controller is configured to further display, on the display, an image indicating a correspondence between the event highlighted in the list image and the edited video.

7. The information processing apparatus according to claim 3, wherein
the information processing apparatus is capable of communicating with a measurement apparatus that measures a predetermined physical quantity, and
the controller is configured to
acquire information indicating a change over time in the physical quantity measured by the measurement apparatus between the end of the first patrol schedule and the start of the second patrol schedule, and
further display, on the display, a graph indicating the change over time in the physical quantity measured by the measurement apparatus between the end of the first patrol schedule and the start of the second patrol schedule.

8. The information processing apparatus according to claim 7, wherein the controller is configured to
determine that the event has occurred by the physical quantity measured by the measurement apparatus satisfying a predetermined condition, and
further display, on the display, an event image indicating occurrence of the determined event at a position on the graph corresponding to the time and the physical quantity of the determined event.

9. The information processing apparatus according to claim 8, wherein the controller is configured to further display, as the list image on the display, an image that further includes a display of the time of occurrence and the type of each event determined based on the physical quantity.

10. The information processing apparatus according to claim 9, wherein the controller is configured to further display, on the display, an image indicating a correspondence between the event image and the display in the list image of the event indicated by the event image.

11. The information processing apparatus according to claim 1, wherein the controller is configured to further display, on the display, an image indicating a temporal position of the edited video currently displayed on the display.

12. A control method of an information processing apparatus capable of communicating with an imaging apparatus that captures video composed of a plurality of frame images, the control method comprising:
controlling, by a controller of the information processing apparatus, the imaging apparatus to capture images in a fixed imaging range according to a preset patrol schedule;
acquiring, by the controller, an edited video generated by editing a recorded video that is a video captured by the imaging apparatus between an end of a first patrol schedule and a start of a second patrol schedule, which is a next patrol schedule after the first patrol schedule;
acquiring, by the controller, a live video that is video captured by the imaging apparatus according to the second patrol schedule; and
displaying, by the controller, the live video and the edited video on a display.

13. A program configured to cause a computer to perform operations comprising:
controlling an imaging apparatus to capture video composed of a plurality of frame images in a fixed imaging range according to a preset patrol schedule;
acquiring an edited video generated by editing a recorded video that is a video captured by the imaging apparatus between an end of a first patrol schedule and a start of a second patrol schedule, which is a next patrol schedule after the first patrol schedule;
acquiring a live video that is video captured by the imaging apparatus according to the second patrol schedule; and
displaying the live video and the edited video on a display.
